(19) United States
(12) Patent Application Publication
(10) Pub. No.: US 2025/0334714 A1
(43) Pub. Date: Oct. 30, 2025

(54) SIPHON RAIN GAUGE SYSTEM

(71) Applicant: Weida Hi-tech Corporation Ltd., Hsinchu City (TW)

(72) Inventors: JEN-CHUAN WANG, Hsinchu City (TW); CHIH-KUEI WU, Miaoli County (TW); SHIH-MING WU, Taoyuan City (TW); ZI-HUAN LUO, Taoyuan City (TW)

(21) Appl. No.: 19/085,595

(22) Filed: Mar. 20, 2025

(30) Foreign Application Priority Data
Apr. 25, 2024 (TW) 113115602

(51) Int. Cl. G01W 1/14; G01F 9/00

(52) U.S. Cl. CPC G01W 1/14; G01F 9/001

(57) ABSTRACT

A siphon rain gauge system, comprising: a rain collector, a measuring cup, a siphon drain pipe, and a sensing unit. The rain collector provides an inlet for rainwater to enter and an outlet for collected rainwater to flow out. The measuring cup has a drain pipe directly connected to the outlet of the rain collector to collect the rainwater flowing out from the outlet. The siphon drain pipe is connected to the measuring cup for discharging the rainwater from the measuring cup. When the liquid level height of the rainwater in the measuring cup is greater than siphon drain pipe, the siphon drain pipe discharges the rainwater from the measuring cup. The sensing unit is disposed within the measuring cup or outside the measuring cup for sensing the liquid level height of the rainwater to generate a sensing signal, and the system calculates rainfall based on the sensing signal.

### CROSS-REFERENCE TO RELATED APPLICATIONS

This application claims priority of No. 113115602 filed in Taiwan R.O.C. on Apr. 25, 2024 under 35 USC 119, the entire contents of which are hereby incorporated by reference.

### FIELD OF THE INVENTION

The present invention relates to a rain gauge system, and more particularly, to a siphon rain gauge system having a micro control unit (MCU) and a sensor that replaces a magnetic reed switch.

### DESCRIPTION OF RELATED ART

As shown in FIG. 1A, FIG. 1A shows a conventional rain gauge 100. The conventional rain gauge 100 includes a tipping bucket 1. Rainwater enters a rain collector 2 and then flows into a buffer funnel 3. The buffer funnel 3 allows the rainwater to gradually flow into the tipping bucket 1. When one rain gauge bucket of the tipping bucket 1 is filled, the weight of the rainwater causes the rain gauge bucket to tip. When one rain gauge bucket is filled with rainwater, it contacts a magnetic reed switch 4 to generate a pulse signal. At this time, the rainwater in the rain gauge bucket is discharged due to the tipping of the rain gauge bucket. The conventional rain gauge estimates the rainfall amount based on the number of pulse signals, i.e., the number of times the rain gauge bucket is filled with rainwater.

FIG. 1B shows the amount of rainfall filled in the tipping bucket when it tips over corresponding to different simulated rainfall intensities. Because the tipping bucket 1 of the conventional rain gauge 100 directly discharges rainwater, the volume of water measured by each tip of the tipping bucket 1, calculated from the weight of the water, exhibits a gradual increasing trend as the rainfall intensity (simulated rainfall intensity) increases. That is, within the very short period of the tipping bucket 1's inversion, continuous rainfall inflow causes the conventional rain gauge 100 to register a tipped volume that is actually higher than the nominal capacity, yet it is still recorded as a single tip. Consequently, this leads to an underestimation of the precipitation reading, thereby potentially producing a larger error.

Furthermore, the conventional rain gauges 100 require a buffer funnel 3 (i.e., a siphon regulator) to control errors. However, the buffer funnel 3 (the siphon regulator) is easily clogged and damaged from debris such as leaves. Moreover, the buffer funnel 3 itself lacks standard verification and calibration procedures. When rainfall intensity exceeds 200 mm/hour, the conventional rain gauges 100 often exceed the standard tolerance of +3%. Additionally, the magnetic reed switch 4 can become less sensitive to contact due to falling environmental debris, resulting in errors.

### SUMMARY OF THE INVENTION

The present invention discloses describes a siphon rain gauge system that does not require a buffer funnel.

The present invention discloses a siphon rain gauge system in which rainwater is discharged into a measuring cup after being poured from a rain gauge bucket.

The present invention discloses a siphon rain gauge system that uses a sensing unit to sense the liquid level height of rainwater in the measuring cup.

The present invention discloses a siphon rain gauge system that uses the sensing unit to sense the duration of rainwater drainage or the number of drainage occurrences of rainwater in a siphon drain pipe, thereby calculating the rainfall amount.

The present invention discloses a siphon rain gauge system, comprising: a rain collector, a tipping bucket, a measuring cup, a siphon drain pipe, and a sensing unit. The rain collector provides an inlet for rainwater to enter and an outlet for rainwater inside to flow out. The tipping bucket includes at least two rain gauge buckets disposed on opposite sides of a tipping axis. The rain gauge buckets alternately collect the rainwater flowing out from the rain collector. Based on the weight of the rainwater, the rain gauge buckets alternately tip on either side of the tipping axis, causing the drain openings of the rain gauge buckets to rise and fall on either side of the tipping axis. As a rain gauge bucket descends, its rainwater flows out of the tipping bucket and into the measuring cup. As the rain gauge bucket buckets descend, rainwater flows into the measuring cup. The siphon drain pipe is connected to the measuring cup and discharges the rainwater from the measuring cup via the siphon principle. When the liquid level of the rainwater in the measuring cup is higher than the highest point of the siphon drain pipe, the siphon drain pipe discharges the rainwater from the measuring cup. The sensing unit is disposed within the siphon drain pipe or the measuring cup for sensing the number of times or the duration of rainwater drainage, or the liquid level height, thereby generating a sensing signal, the system calculating rainfall based on the sensing signal.

The present invention discloses a siphon rain gauge system, comprising: a rain collector, a measuring cup, a siphon drain pipe, and a sensing unit. The rain collector provides an inlet for rainwater to enter and an outlet for collected rainwater to flow out. The measuring cup collects rainwater flowing from the outlet. The siphon drain pipe is connected to the measuring cup for discharging the rainwater from the measuring cup. When the liquid level height of the rainwater in the measuring cup is greater than the highest point of the siphon drain pipe, the siphon drain pipe discharges the rainwater from the measuring cup. The sensing unit is disposed within the measuring cup or outside the measuring cup for sensing the liquid level height of the rainwater to generate a sensing signal, and the system calculates rainfall based on the sensing signal.

### BRIEF DESCRIPTION OF DRAWINGS

FIG. 1A shows a conventional rain gauge.

FIG. 1B shows the amount of rainfall filled in the tipping bucket when it tips over corresponding to different simulated rainfall intensities.

FIG. 2A shows a schematic diagram of the siphon rain gauge system of the present invention.

FIG. 2B shows a schematic diagram of the operation of the tipping bucket 21.

FIG. 3A shows a schematic diagram of the siphon rain gauge system of the present invention.

FIG. 3B shows a top view of the measuring cup 22 and the sensing unit 24 (with a projected capacitance 24a disposed within the measuring cup 22) of FIG. 3A.

FIG. 3C shows a schematic diagram of the siphon rain gauge system of the present invention.

FIG. 3D shows a top view of the measuring cup 22 and the sensing unit 24 (with a projected capacitance sensor 24a disposed outside of the measuring cup 22) of FIG. 3C.

FIGS. 4-5 show the siphon rain gauge system of the present invention.

FIG. 6 shows a schematic diagram of the siphon rain gauge system of the present invention.

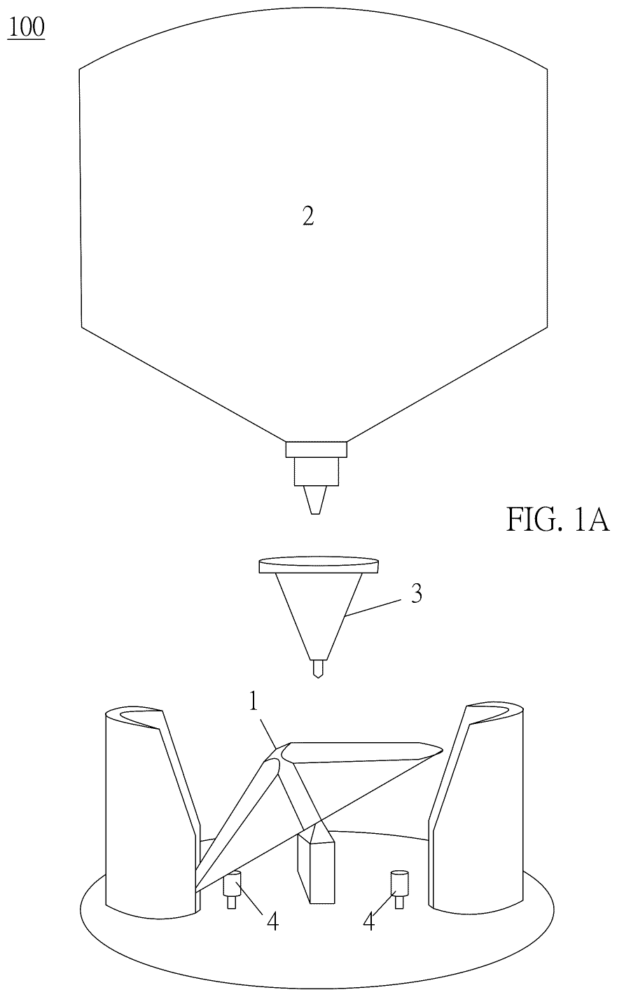

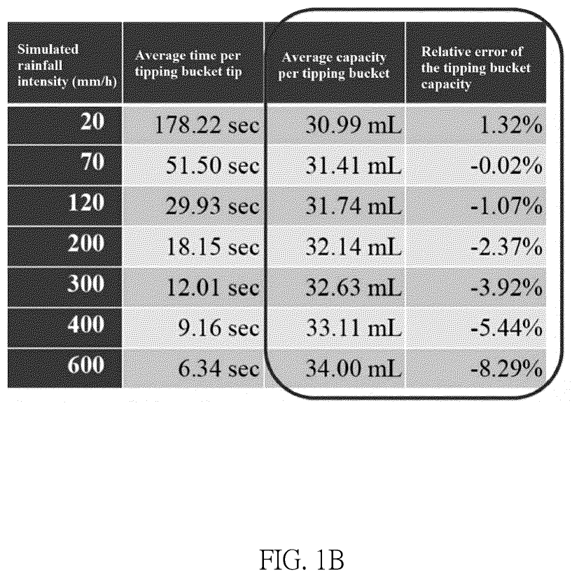

### DETAILED DESCRIPTION OF THE INVENTION

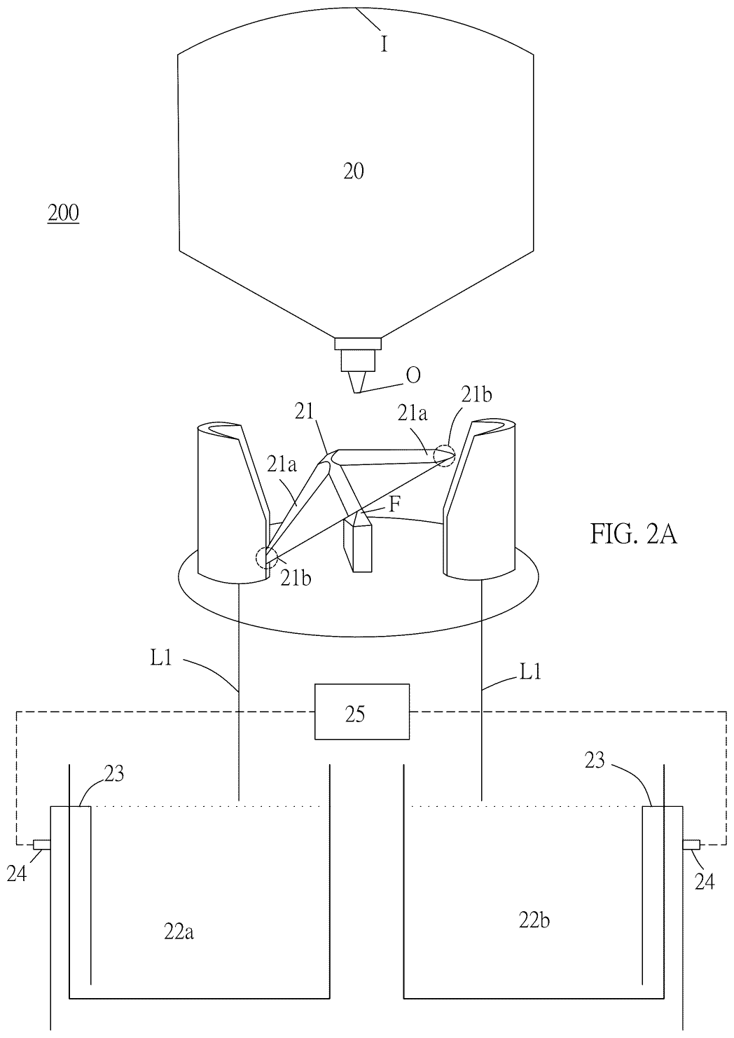

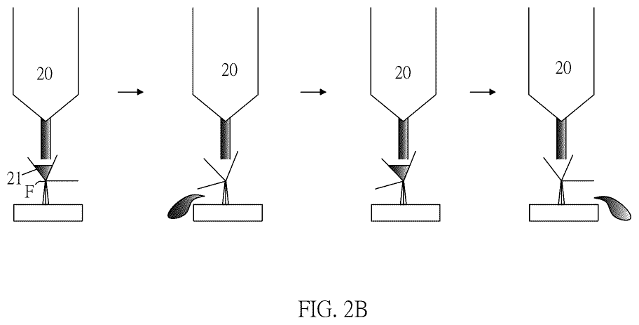

Please refer to FIG. 2A, which shows a schematic diagram of the siphon rain gauge system of the present invention, the siphon rain gauge system 200 includes a rain collector 20, a tipping bucket 21, measuring cups 22a and 22b, a siphon drain pipe 23, and a sensing unit 24.

Please also refer to FIG. 2B, which shows a schematic diagram of the operation of the tipping bucket 21, the rain collector 20 provides an inlet I for rainwater to enter and an outlet O for the collected rainwater to flow out. The tipping bucket 21 has at least two rain gauge buckets 21a; in this embodiment, two rain gauge buckets 21a are provided, each disposed on opposite sides of a tipping axis F. The rain gauge buckets 21a alternately collect the rainwater flowing out from the rain collector 20. Based on the weight of the rainwater, the rain gauge buckets 21a alternately tip on either side of the tipping axis F, causing their respective drain openings 21b to rise and fall. As the rain gauge buckets 21a alternately rise and fall based on the weight of the collected rainwater, the tipping bucket 21 acts like a seesaw, with a rain gauge bucket 21a collecting rainwater from the rain collector 20 when in the raised position. When a rain gauge bucket 21a is filled with rainwater, it descends, causing the other rain gauge bucket 21a to rise, and this process is repeated to collect rainwater. When a rain gauge bucket 21a descends, the rainwater within the corresponding rain gauge bucket 21a flows out from the drain opening 21b into the measuring cup 22a or 22b. In other words, the tipping bucket 21 drains into the measuring cup 22a or 22b.

The measuring cups 22a and 22b are each equipped with a drain pipe L1 that connects to the drainage position of the rain gauge bucket 21a. As the rain gauge bucket 21a descends, rainwater flows through the drainage pipe L1 into either measuring cup 22a or 22b. The siphon drain pipe 23 is connected to either measuring cup 22a or 22b and discharges the rainwater from the respective measuring cup via the siphon principle. When the water level in measuring cups 22a or 22b exceeds the highest point of the siphon drain pipe 23, the siphon drain pipe 23 discharges the rainwater from the measuring cups 22a or 22b.

In another embodiment, the measuring cups 22a and 22b do not have drain pipes, as long as the position of the drain opening 21b during drainage is aligned with the measuring cup 22a or 22b, so that the rainwater from the corresponding rain gauge bucket 21a flows into the measuring cup 22a or 22b from the drain opening 21b.

Please note that, in this embodiment, the sensing unit 24 is disposed at the siphon drain pipe 23 to sense the duration of rainwater drainage from the siphon drain pipe 23 and generate a sensing signal. The system 200 calculates the rainfall based on the sensing signal. Therefore, the sensing unit 24 is a drainage sensing unit and is used to sense the duration of rainwater drainage from the siphon drain pipe 23.

This embodiment, having two measuring cups 22a and 22b for collecting rainwater, differs from the prior art in that it does not require the buffer funnel or siphon regulator of conventional rain gauges, and rainwater does not drain directly from the tipping bucket 21 to the outside of the siphon rain gauge system 200. Instead, the rainwater is temporarily stored in the measuring cups 22a and 22b.

Furthermore, when the measuring cup 22a or 22b is filled with rainwater, the siphon drain pipe 23 will automatically initiate drainage. In this embodiment, the drainage time of the siphon drain pipe 23 is less than the time it takes for any one of the rain gauge buckets 21a to fill. This prevents errors in rainfall calculation that could occur if the tipping bucket 21 continues to drain rainwater into a measuring cup 22a or 22b while the siphon drain pipe 23 is draining. That is, when the left measuring cup 22a is full, it automatically drains via the siphon (siphon drainage time<the rain gauge bucket 21a fill time), while the right measuring cup 22b can still record the accumulated rainfall. Similarly, when the right measuring cup 22b is full and automatically drains via the siphon, the left measuring cup 22a can still record the accumulated rainfall.

Therefore, this embodiment differs from the conventional tipping bucket rain gauge in that it does not discharge rainwater directly from the tipping bucket out of the system. Furthermore, this embodiment is compatible with current conventional rain gauge 100 and does not require a precisely leveled buffer funnel, resulting in reduced error in the system 200. The accuracy of this embodiment is unaffected by the volume of the rainfall. Utilizing two measuring cups 22a and 22b increases the recording frequency, enabling measurement of instantaneous rainfall.

Additionally, the system 200 includes an MCU 25 coupled to the sensing unit 24 for calculating rainfall or controlling the sensing interval of the sensing unit 24.

In one embodiment, the MCU 25 can electronically emulate the pulse signal transmission of the conventional rain gauge 100, reducing the need for component replacement in the conventional rain gauge. In other words, the drainage of the left and right measuring cups 22a and 22b can utilize the MCU 25 to generate an electronic signal that simulates the signal (pulse signal) transmitted by the magnetic reed switch of the rain gauge bucket 21a. Specifically, when the measuring cup 22a is full and automatically drains via the siphon, the drainage sensing unit 24 notifies the MCU 25 to generate a pulse signal. Similarly, when the measuring cup 22b is full and automatically drains via the siphon, the drainage sensing unit 24 notifies the MCU 25 to generate a pulse signal. This approach reduces the cost and learning curve associated with replacing software toolkits on the host (HOST) side.

Instead of recording the number of tipping bucket cycles, accumulated rainfall can also be calculated by recording the number of drainage times of the left and right measuring cups 22a and 22b, which results in smaller errors (the MCU 25 sends a drainage pulse signal for each drainage event). However, the accumulated rainfall for each measuring cup can only be calculated after the measuring cups 22a and 22b are full and their respective sensing units 24 generate a drainage pulse signal. If the capacity of the measuring cup is greater than 33.33 times the capacity of the rain gauge bucket, the error can be less than the standard tolerance of ±3%. This embodiment can also be implemented with a single measuring cup.

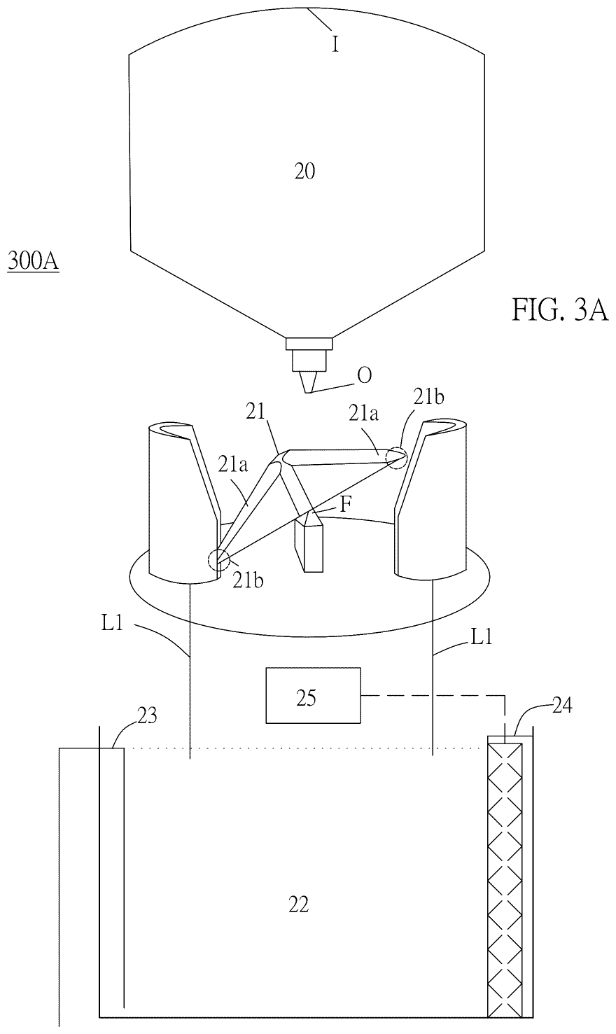

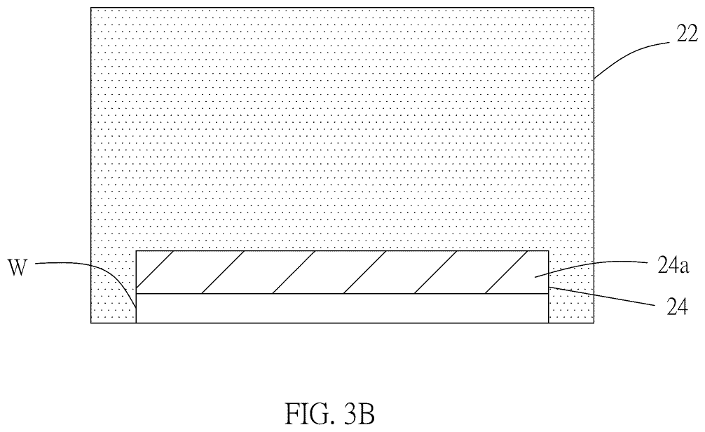

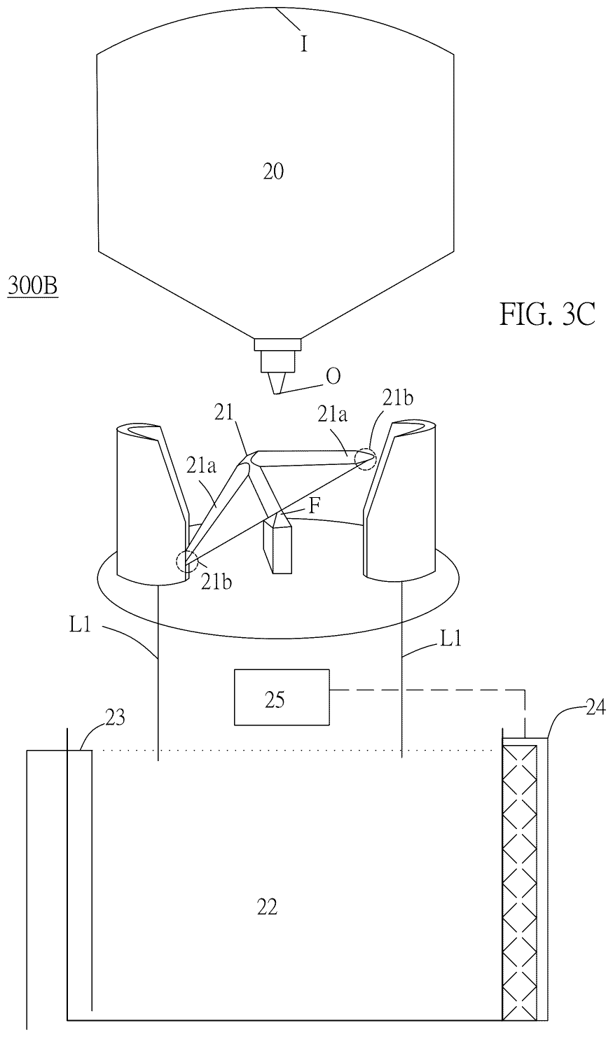

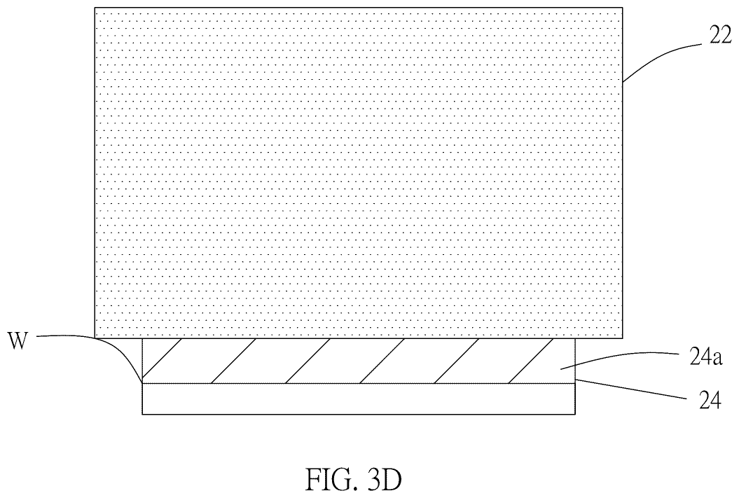

In another embodiment (FIG. 3B or FIG. 3D), the sensing unit 24 is implemented as a projected capacitance sensor, which does not come into direct contact with the rainwater. The rainwater in the siphon drain pipe 23 contacts the outer wall W of the sensing unit 24, changing the capacitance value of the projected capacitance sensor. Because the mutual capacitance projected capacitance sensor does not require grounding in the liquid level measurement area and its structure does not include a reference capacitor or resistor, it can be disposed at any position within the measuring cup 22 for non-contact sensing. This further prevents damage that could be caused by direct contact between the circuitry and rainwater. Finally, the MCU 25 of system 300A or 300B senses the drainage time of the siphon drain pipe 23 based on the change in the capacitance value of the projected capacitance sensor. In other words, the sensing unit 24 is a liquid level sensing unit used to sense the liquid level height in the measuring cup 22.

Please referring to FIG. 3A, which shows a schematic diagram of the siphon rain gauge system of the present invention, the siphon rain gauge system 300A includes a rain collector 20, a tipping bucket 21, a measuring cup 22, a siphon drain pipe 23, a sensing unit 24, and an MCU 25.

Please note that the siphon rain gauge system 300A of the present invention differs from system 200 in that system 300A has only one measuring cup 22. Rainwater discharged from the rain gauge buckets 21a flows into the same measuring cup 22, and the sensing unit 24 is disposed within the measuring cup 22. The remaining operating principles are the same as described above and will not be repeated here.

Because the rainwater in this embodiment is collected in a single measuring cup 22, the liquid level sensing method is used to measure the rainfall height; that is, the sensing unit 24 is used to sense the liquid level height in the measuring cup 22. Because only a single measuring cup 22 is used, when the measuring cup 22 is full, it automatically drains through the siphon drain pipe 23. When the drainage time is less than one cycle (the time it takes for the rain gauge bucket 21a to fill), no error occurs. However, when the drainage time is greater than one cycle, the error caused by rainwater from the rain gauge bucket 21a flowing into the measuring cup 22 can be compensated for using linear prediction based on past data recorded by the MCU 25. That is, The MCU 25 estimates the current error value using the flow rate of rainwater into measuring cup 22 from previous measurements.

In this embodiment, for accumulated rainfall calculation, the MCU 25 can directly read the liquid level height in the measuring cup sensed by the sensing unit 24 at any time, or the MCU 25 can send a signal indicating the liquid level height to the host at fixed intervals.

Please note that the MCU 25 can increase the recording frequency of the liquid level height in the measuring cup sensed by the sensing unit 24. For example, if the rainfall intensity is less than 20 mm/h, the recording frequency can be once every 30 seconds; if the rainfall intensity is 200 mm/h, the recording frequency can be once every 3 seconds; and if the rainfall intensity is 600 mm/h, the recording frequency can be once every second. The sampling frequency of the MCU 25 can be adjusted using the past rainfall increase rate, for example, by referencing the rainfall intensity over the previous 1 to 10 minutes, to make instantaneous rainfall measurements more accurate.

Please also refer to FIG. 3B, which shows a top view of the measuring cup 22 and the sensing unit 24 (with the projected capacitance sensor 24a disposed within the measuring cup 22) of FIG. 3A. In this embodiment, the sensing unit 24 includes a projected capacitance sensor 24a, which does not directly contact the rainwater. The projected capacitance sensor 24a is disposed within the measuring cup 22, and the outer wall W of the sensing unit 24 is in contact with the inner wall of the measuring cup 22. The outer wall W surrounds and encloses the projected capacitance sensor, thus isolating it from the rainwater to prevent direct contact. Rainwater within the measuring cup contacts the outer wall W of the sensing unit 24, changing the capacitance value of the projected capacitance sensor 24a. System 300A senses the liquid level height in the measuring cup 22 based on this change in capacitance. The projected capacitance sensor 24a is a mutual capacitance type. The remaining principles are the same as described above.

Please note that the sensing unit of the aforementioned systems 200 or 300A can be a resistive sensing unit, which directly contacts the rainwater. The rainwater within the measuring cup 22 or the siphon drain pipe 23 contacts the resistive sensing unit, changing its voltage value. The MCU 25 of system 200 or 300A senses the drainage time of the siphon drain pipe 23 or the liquid level height in the measuring cup 22 based on this change in voltage. The remaining principles are the same as described above and will not be repeated here.

Please refer to FIGS. 3C and 3D, in one embodiment, FIG. 3C shows a schematic diagram of the siphon rain gauge system of the present invention, and FIG. 3D shows a top view of the measuring cup 22 and sensing unit 24 (with the projected capacitance sensor 24a disposed outside the measuring cup 22) of FIG. 3C. Note that system 300B differs from system 300A in that the projected capacitance sensor 24a of system 300B is disposed outside the measuring cup 22. The rainwater within the measuring cup changes the capacitance value of the projected capacitance sensor 24a. The remaining principles are the same as described above and will not be repeated here.

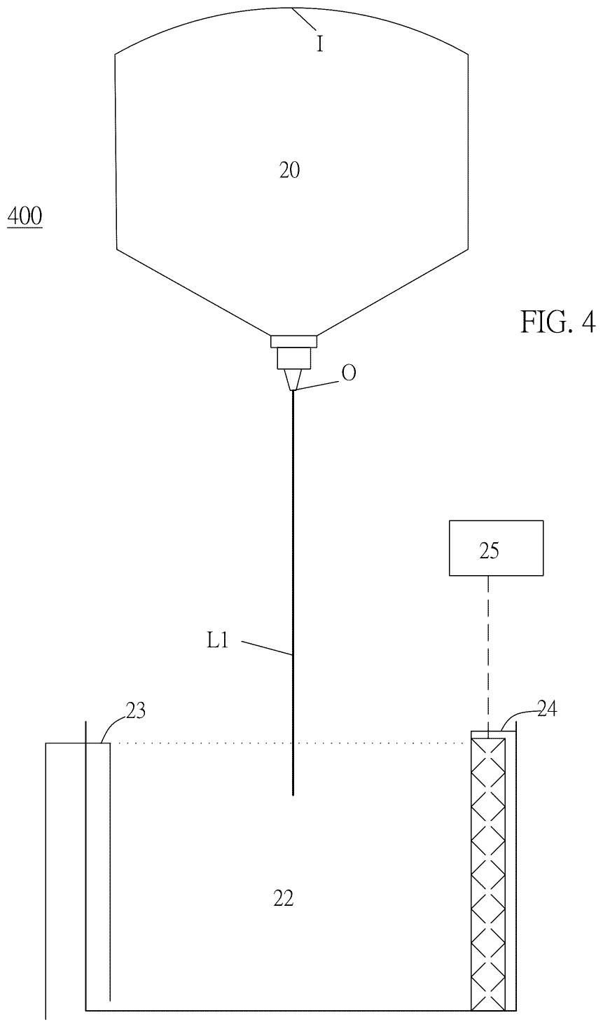

Please refer to FIG. 4, which shows a schematic diagram of siphon rain gauge system 400 of the present invention, the siphon rain gauge system 400 includes a rain collector 20, a measuring cup 22, a siphon drain pipe 23, a sensing unit 24, and an MCU 25.

Please note that the siphon rain gauge system 400 of the present invention differs from system 300A in that system 400 does not have a tipping bucket. That is, the drain pipe L1 is directly connected to the outlet of rain collector 20, and the rain collector 20 directly discharges rainwater into the measuring cup 22.

In this embodiment, the siphon rain gauge system 400 utilizes a single measuring cup 22 and a sensing unit 24 to sense the liquid level height within the measuring cup 22, enabling the MCU 25 to calculate rainfall. With a single measuring cup 22, when it fills, the cup automatically drains through the siphon drain pipe 23. Any error caused by rainwater flowing into the measuring cup 22 during the drainage period can be compensated for using linear prediction. The MCU 25 estimates this error value using past flow rate data. Because the MCU 25 records the start and end times of the measuring cup 22 drainage, it uses the change in liquid level height sensed by the sensing unit 24, along with past flow rate data, to perform linear prediction compensation.

Regarding the calculation of accumulated rainfall: the MCU 25 can directly read the liquid level height within the measuring cup 22 sensed by the sensing unit 24 at any time, or the MCU 25 can transmit the liquid level height signal to the host at fixed intervals. Because the sensing unit 24 is used to sense liquid level height, the system can increase the recording frequency via the MCU 25 through the sensing unit 24. For example, if the rainfall intensity is less than 20 mm/h, the recording can be performed once every 30 seconds; if the rainfall intensity is 200 mm/h, the recording can be performed once every 3 seconds; and if the rainfall intensity is 600 mm/h, the recording can be performed once every second. By using the past rainfall increase rate, for example, by referencing the rainfall intensity over the previous 1 to 10 minutes, the sampling frequency of the MCU 25 can be adjusted to make instantaneous rainfall measurements more accurate. The remaining principles are the same as described above and will not be repeated here.

In one embodiment, the system 400 does not have the drain pipe L1, as long as the rainwater flowing from the outlet of the rain collector 20 can flow into the measuring cup 22. In addition, the projected capacitance sensor 24a can also be disposed on the outer wall of the measuring cup 22.

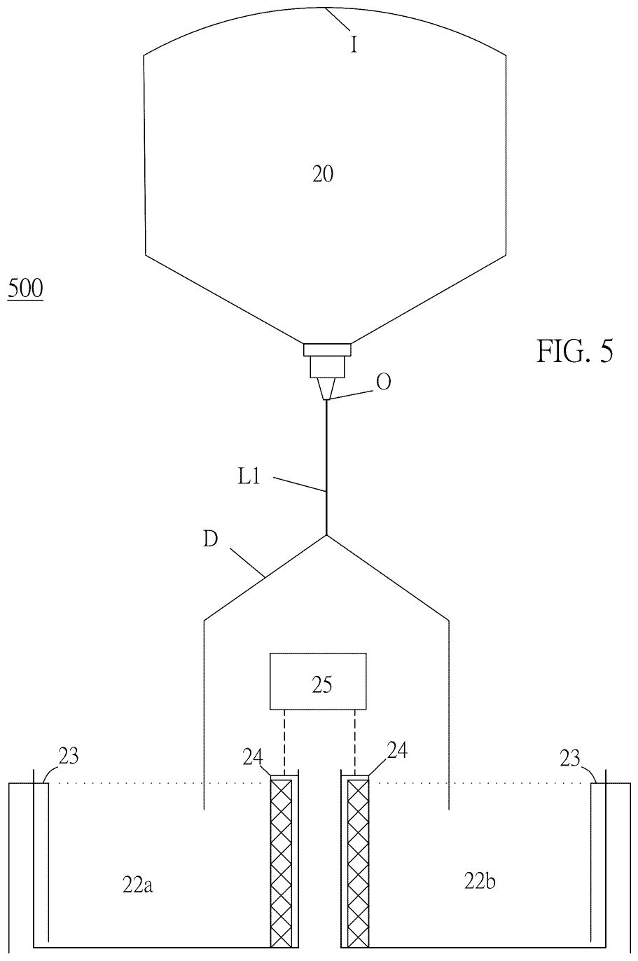

Please refer to FIG. 5, which shows a schematic diagram of the siphon rain gauge system 500 of the present invention, the siphon rain gauge system 500 includes a rain collector 20, measuring cups 22a and 22b, a siphon drain pipe 23, a sensing unit 24, and an MCU 25.

Please note that siphon rain gauge system 500 of the present invention differs from system 400 in that system 500 includes measuring cups 22a and 22b. The drain pipe L1 is directly connected to the outlet of the rain collector 20, and the drain pipe L1 has a branch pipe D. The branch pipe D causes the rainwater from the rain collector 20 to be diverted through the branch pipe D to the measuring cups 22a and 22b. The volume ratio of the measuring cups 22a and 22b is a ratio of adjacent prime numbers.

In this embodiment, the measuring cups 22a and 22b each use a sensing unit 24 to sense the liquid level height of the rainwater within the measuring cups 22a and 22b. Using dual measuring cups 22a and 22b for mutual prediction, in one embodiment the accuracy is set to within ±1.5%. Rainwater is directed through branch pipe D into the dual measuring cups 22a and 22b, thereby eliminating the need for a tipping bucket. Because the volume ratio of the measuring cups 22a and 22b is a ratio of two adjacent prime numbers, for example, 17 to 19, the probability of simultaneous drainage from the measuring cups 22a and 22b coinciding is 1/323 (approximately 3 per thousand). The drainage time of the siphon drain pipe 23 must be less than T/19 (where T=the time for a measuring cup to fill), meaning that the drainage time of the corresponding siphon drain pipe 23 is less than the time it takes for the measuring cup 22a or 22b to fill with rainwater divided by the largest of the adjacent prime numbers.

When measuring cup 22a or 22b is draining, the measuring cup 22a or 22b continues to accumulate rainwater (or collect rainwater). At this time, the error can be estimated using the flow rate of the other measuring cup. The MCU 25 can record the start/end time of the siphon drain pipe 23 drainage, and the increase or decrease in liquid level height of the measuring cup 22a or 22b sensed by the sensing unit 24. If the measuring cups 22a and 22b are draining simultaneously, then the flow rate of the siphon drain pipe 23 is estimated by the amount of rainwater (accumulated rainfall) that flowed into each measuring cup 22a or 22b before drainage. In other words, the measured error value is the difference value between the current actual rainfall and the previously accumulated rainfall.

Regarding accumulated rainfall calculation: the MCU 25 can directly read the liquid level height within the measuring cup 22 sensed by the sensing unit 24 at any time, or the MCU 25 can transmit the liquid level height signal to the host at fixed intervals. Since the sensing unit 24 is used to sense the liquid level height, the system can increase the recording frequency via the MCU 25 through the sensing unit 24. For example, if the rainfall intensity is less than 20 mm/h, a recording can be performed once every 30 seconds; if the rainfall intensity is 200 mm/h, a recording can be performed once every 3 seconds; and if the rainfall intensity is 600 mm/h, a recording can be performed once every second. By using the past rainfall increase rate, for example, by referencing the rainfall intensity over the previous 1 to 10 minutes, the sampling frequency of the MCU 25 can be adjusted to make instantaneous rainfall measurements more accurate. The remaining principles are the same as described above and will not be repeated here.

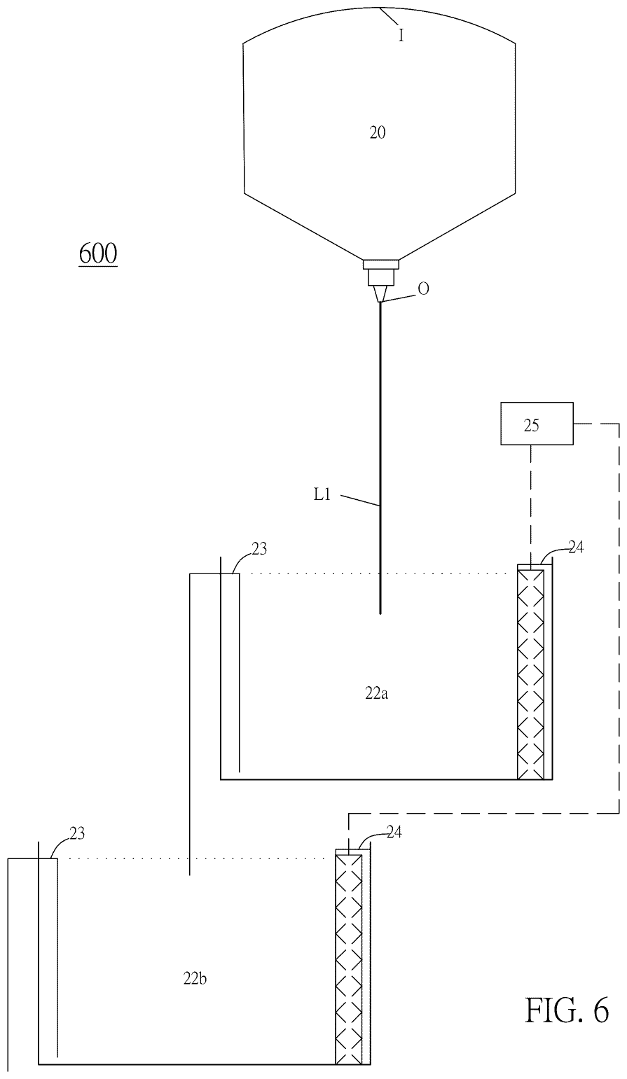

Please refer to FIG. 6, which shows a schematic diagram of a siphon rain gauge system 600 according to an embodiment of the present invention, system 600 differs from system 500 in that system 600 has a serial connected structure. Although system 600 also has two measuring cups 22a and 22b, two siphon drain pipes 23, and two sensing units 24, the rainwater for measuring cup 22b is provided from the siphon drain pipe 23 of measuring cup 22a, whereas the rainwater for measuring cups 22a and 22b of system 500 comes from the rain collector 20. That is, in this embodiment, a hierarchical series connection of measuring cups is formed by connecting a smaller measuring cup 22a to a larger measuring cup 22b. This is capable of adapting to extreme weather conditions, such as sudden torrential rain, heavy rain, or light rainfall. This embodiment can cover a wide detection range to respond to different degrees of rainfall; from light rain to extreme torrential rain, rainwater can be collected effectively. The remaining principles are the same as described above.

In summary, the present invention's continuous liquid level sensing system utilizes a mutual capacitance projected capacitance circuit structure. Because the mutual capacitance projected capacitance sensor does not require grounding in the liquid level measurement area, and its structure does not include a reference capacitor or resistor, it can be disposed at any position with respect to the rainwater for non-contact sensing, further preventing damage that could be caused by direct contact between the circuit and the rainwater. In addition, the more projected capacitance units there are, the higher the measurement accuracy. The present invention features an architecture with additional series-connected projected capacitance units, increasing the flexibility and sensitivity of liquid level measurement.

1. A siphon rain gauge system, comprising:
a rain collector, providing an inlet for rainwater to enter and an outlet for collected rainwater to flow out;
a tipping bucket, including at least two rain gauge buckets, the rain gauge buckets being respectively disposed on opposite sides of a tipping axis; the rain gauge buckets alternately collecting rainwater flowing from the rain collector, the rain gauge buckets alternately tipping on either side of the tipping axis based on the weight of the rainwater, causing drain openings of the rain gauge buckets to rise and fall on either side of the tipping axis; and when any one of the rain gauge buckets descends, the rainwater in the corresponding rain gauge bucket flows out of the tipping bucket, causing the tipping bucket to drain into a measuring cup;
a measuring cup, wherein when the rain gauge buckets descend, rainwater flows into the measuring cup;
a siphon drain pipe, the siphon drain pipe being connected to the measuring cup and discharging the rainwater from the measuring cup via a siphon principle, wherein when a liquid level height of the rainwater in the measuring cup is greater than a highest point of the siphon drain pipe, the siphon drain pipe discharges the rainwater from the measuring cup; and
a sensing unit, disposed within the siphon drain pipe or within the measuring cup or outside of the measuring cup, for sensing the number of times or the duration of rainwater drainage, or the liquid level height, thereby generating a sensing signal, the system calculating rainfall based on the sensing signal.

2. The system according to claim 1, wherein a drainage time of the siphon drain pipe is less than the time it takes for any one of the rain gauge buckets to fill with rainwater.

3. The system according to claim 1, wherein the sensing unit comprises a projected capacitance sensor, the projected capacitance sensor not directly contacting rainwater; the rainwater in the measuring cup or the rainwater in the siphon drain pipe changing a capacitance value of the projected capacitance sensor, thereby causing the system to sense a drainage time of the siphon drain pipe or a liquid level height of the measuring cup based on the change in the capacitance value of the projected capacitance sensor.

4. The system according to claim 2, wherein the sensing unit comprises a projected capacitance sensor, the projected capacitance sensor not directly contacting rainwater; the rainwater in the measuring cup or the rainwater in the siphon drain pipe changing a capacitance value of the projected capacitance sensor, thereby causing the system to sense the drainage time of the siphon drain pipe or a liquid level height of the measuring cup based on the change in the capacitance value of the projected capacitance sensor.

5. The system according to claim 1, wherein the sensing unit is a resistive sensing unit, the resistive sensing unit directly contacting rainwater; the rainwater in the measuring cup or the rainwater in the siphon drain pipe contacting the resistive sensing unit to change a voltage value of the resistive sensing unit, thereby causing the system to sense a drainage time of the siphon drain pipe or a liquid level height of the measuring cup based on the change in the voltage value.

6. The system according to claim 2, wherein the sensing unit is a resistive sensing unit, the resistive sensing unit directly contacting rainwater; the rainwater in the measuring cup or the rainwater in the siphon drain pipe contacting the resistive sensing unit to change a voltage value of the resistive sensing unit, thereby causing the system to sense the drainage time of the siphon drain pipe or a liquid level height of the measuring cup based on the change in the voltage value.

7. The system according to claim 1, wherein the system has a microcontroller coupled to the sensing unit for calculating rainfall or controlling a sensing interval of the sensing unit; and wherein the rain gauge buckets alternately collect rainwater flowing from the rain collector without passing through a buffer funnel.

8. The system according to claim 2, wherein the system has a microcontroller coupled to the sensing unit for calculating rainfall or controlling a sensing interval of the sensing unit; and wherein the rain gauge buckets alternately collect rainwater flowing from the rain collector without passing through a buffer funnel.

9. A siphon rain gauge system, comprising:
a rain collector, providing an inlet for rainwater to enter and an outlet for collected rainwater to flow out;
a measuring cup, collecting rainwater flowing from the outlet;
a siphon drain pipe, the siphon drain pipe being connected to the measuring cup and discharging the rainwater from the measuring cup via a siphon principle, wherein when a liquid level height of the rainwater in the measuring cup is greater than a highest point of the siphon drain pipe, the siphon drain pipe discharges the rainwater from the measuring cup; and
a sensing unit, disposed within the measuring cup or outside of the measuring cup, for sensing the liquid level height of the rainwater to generate a sensing signal, the system calculating rainfall based on the sensing signal.

10. The system according to claim 9, wherein the system has two measuring cups and a drain pipe, the drain pipe being directly connected to the outlet of the rain collector, and the drain pipe being coupled to a branch pipe, such that the rainwater from the rain collector is diverted through the branch pipe to the measuring cups; wherein a volume ratio of the measuring cups is a ratio of two adjacent prime numbers, and a drainage time of the siphon drain pipe is less than a time for the measuring cups to fill with rainwater divided by a largest of the adjacent prime numbers.

11. The system according to claim 9, wherein the sensing unit comprises a projected capacitance sensor, the projected capacitance sensor not directly contacting the discharged rainwater; the rainwater in the measuring cup changing a capacitance value of the projected capacitance sensor, thereby causing the system to calculate a liquid level height of the measuring cup based on the change in the capacitance value of the projected capacitance sensor.

12. The system according to claim 10, wherein the sensing unit comprises a projected capacitance sensor, the projected capacitance sensor not directly contacting the discharged rainwater; the rainwater in the measuring cup changing a capacitance value of the projected capacitance sensor, thereby causing the system to calculate a liquid level height of the measuring cup based on the change in the capacitance value of the projected capacitance sensor.

13. The system according to claim 9, wherein the sensing unit is a resistive sensing unit, the resistive sensing unit directly contacting the rainwater; the rainwater in the measuring cup or the rainwater in the siphon drain pipe contacting the resistive sensing unit to change a voltage value of the resistive sensing unit, thereby causing the system to sense a drainage time of the siphon drain pipe or a liquid level height of the measuring cup based on the change in the voltage value.

14. The system according to claim 10, wherein the sensing unit is a resistive sensing unit, the resistive sensing unit directly contacting the rainwater; the rainwater in the measuring cup or the rainwater in the siphon drain pipe contacting the resistive sensing unit to change a voltage value of the resistive sensing unit, thereby causing the system to sense the drainage time of the siphon drain pipe or a liquid level height of the measuring cup based on the change in the voltage value.

15. The system according to claim 11, wherein the projected capacitance sensor is not disposed in a region containing the rainwater, and an outer wall serves as part of the measuring cup.

16. The system according to claim 12, wherein the projected capacitance sensor is not disposed in a region containing the rainwater, and an outer wall serves as part of the measuring cup.

17. The system according to claim 11, wherein the projected capacitance sensor is disposed in a region containing the rainwater, an outer wall of the projected capacitance sensor blocks the rainwater, the outer wall preventing the projected capacitance sensor from directly contacting the rainwater, the outer wall being disposed within the measuring cup.

18. The system according to claim 12, wherein the projected capacitance sensor is disposed in a region containing the rainwater, an outer wall of the projected capacitance sensor blocks the rainwater, the outer wall preventing the projected capacitance sensor from directly contacting the rainwater, the outer wall being disposed within the measuring cup.

19. The system according to claim 9, wherein the system has a microcontroller coupled to the sensing unit, and calculates the rainfall or controls a sensing frequency of the sensing unit.

20. The system according to claim 10, wherein the system has a microcontroller coupled to the sensing unit, and calculates the rainfall or controls a sensing frequency of the sensing unit.
